(19) United States
(12) Patent Application Publication
(10) Pub. No.: US 2014/0028833 A1
(43) Pub. Date: Jan. 30, 2014

(54) INSPECTION DEVICE

(71) Applicants: Franco Craveiro, Hauterive (CH); Pierrick Abrial, Neuchatel (CH); Yaw Yoong Sia, Kajang (MY)

(72) Inventors: Franco Craveiro, Hauterive (CH); Pierrick Abrial, Neuchatel (CH); Yaw Yoong Sia, Kajang (MY)

(73) Assignee: ISMECA SEMICONDUCTOR HOLDING SA, La Chaux-de-Fonds (CH)

(21) Appl. No.: 14/002,084

(22) PCT Filed: Mar. 5, 2012
(86) PCT No.: PCT/EP2012/053756

§ 371 Date: Aug. 28, 2013

(30) Foreign Application Priority Data
Apr. 18, 2011 (CH) 0683/11

(51) Int. Cl. G01N 21/88

(52) U.S. Cl. CPC G01N 21/8806
USPC 348/131

(57) ABSTRACT

An inspection device, suitable for use when inspecting a component for defects, including a cluster of lights which are arranged into two or more groups of lights, wherein the cluster of lights is configured such that each group of lights can be operated asynchronously to the other group(s) of lights so that light can be directed asynchronously at a component, from different directions; an image capturing means which is configured to capture an image of a component when each of the groups of lights are lit, to provide a plurality of images, each image showing the component lit from a different direction; a processing means configured to perform arithmetic computation using the images, so as to provide a single image in which defects in the component can be more easily identified. Also, a corresponding method of inspecting a component and a lighting arrangement with a dome and a diffuser.

### FIELD OF THE INVENTION

The present invention relates to an inspection device, in particular, but not exclusively, the present invention relates to an inspection device which uses a lighting system which lights a component from different directions and which uses images of the component when lit from the different directions to allow defects on the component to be more easily identified. The invention also relates to a corresponding method of inspecting a component and a lighting arrangement usable to light a component which is to be inspected.

### DESCRIPTION OF RELATED ART

Components, for example electrical components such a LEDs, are usually tested for defects during the manufacturing process. The components which are to be inspected for defects are usually illumined using a lighting system; illuminating the components allows defects on the component to be more easily identified.

Current lighting systems are configured to illuminate simultaneously, each side of the component which is being inspected. Once illuminated a camera takes an image of the illuminated components; the image is then inspected to identify defects on the component. However, disadvantageously, illuminating the component from each side can make it difficult to identify surface defects on a component; as the component is illuminated from each side, defects will not cast a shadow; accordingly the surface defect is less obvious from the image and thus more difficult to identify.

To enable defects to be more easily identified, it is known to illuminate the component from either side and to obtain equations which characterises the light reflected by the component when lit from each side. The equations are solved as differential equations to identify the defects in the component. Such systems and methods for identifying defects in components are complex, expensive and take a long time to provide results.

It is an aim of the present invention to obviate or mitigate one or more of the aforementioned disadvantages.

### BRIEF SUMMARY OF THE INVENTION

According to the present invention, there is provided an inspection device, suitable for use when inspecting a component for defects, the inspection device comprising, a cluster of lights which are arranged into two or more groups of lights, wherein the cluster of lights is configured such that each group of lights can be operated asynchronously to the other group(s) of lights so that light can be directed asynchronously at a component, from different directions; an image capturing means which is configured to capture an image of a component when each of the groups of lights are lit, to provide a plurality of images, each image showing the component lit from a different direction; a processing means configured to perform arithmetic computation using the images, so as to provide a single image in which defects in the component can be more easily identified.

Advantageously, the lighting system of the present invention enables the component which is to be inspected to be lit, asynchronously, by light which is incident on the component from different directions. When the component is lit from different directions, asynchronously, depending on the direction in which a defect on the component is orientated, the defect will cast a definitive shadow when light is incident on the component in a direction which is, for example, perpendicular to the direction in which a defect on the component is orientated. Components which are, for example, parallel to the incident light will not cast such a prominent shadow. A camera can be used to take an image of the component. As the light from at least some sides of the rectangle will not be illuminated, the shadow cast by the defect will appear more prominent in the image, thus allowing the defect to be easily identified. The lights are then turned off and the lights at the other sides of the rectangle are then used to illuminate the component from a different direction; in this case the light will be incident on the component from a different direction; defects which are, for example, perpendicular to this incident light will now cast a shadow. Once again an image can be taken using a camera and as the light from at least some sides of the rectangle are not illuminated, the shadow which is cast by the defect will be prominent in the image, thus allowing the defect to be easily identified. Thus, using the lighting system of the present invention, a number of images can be obtained, each of which was taken when the component was lit by light which is incident on the component from a different direction. By lighting the component asynchronously from different directions, each defect irrespective of it direction, will cast a prominent shadow which will be easily seen in an image taken by a camera. These images are then processed by a processing means; the processing means performs simple arithmetic computation which is quick and easy to perform, such as adding, subtracting or dividing the images, to provide a single image in which all defects can be clearly identified. When carrying out the arithmetic computation the pixels of each image will be added to, subtracted from or divided into, corresponding pixels of the other images, to form a single image in which the defects on the component can be easily seen.

The arithmetic computation may comprise linear arithmetic computation.

The linear arithmetic computation may comprises at least one of, addition, subtraction and/or division of the images.

The processing means may be configurable to perform any arithmetic computation. The arithmetic computations may be addition, subtraction and/or division of the images. For example, the addition of images may involve adding pixels of a first image of the component when it was lit from a first direction, with the corresponding pixels of a second image which was obtained by the camera when the component was lit from another direction, to provide a single image whose pixels are an addition of the pixels of each of the first and second images. The arithmetic computation required to provide a single image, may be chosen on the basis of at least one of the following; the component which is being inspected; the defect which is to be indentified; or simply by trial and error.

The inspection device may further comprise a diffuser.

The diffuser may be configured to defuse light coming from the cluster of lights. The diffuser may be configured to defuse light before it reaches a component to be inspected. The diffuser may be configured to defuse light before it reaches a second diffuser. The diffuser may be configured to defuse light before it reaches a dome element which is configured to scatter light

The diffuser may be configured to extend above and below the cluster of lights.

The inspection device may further comprise a dome element which comprises a surface which is configured to scatter light. The dome

The dome element may be configured to scatter light which has been defused by a diffuser.

The dome element may comprise a surface which is configured to scatter light. The surface may be a matt surface. The surface may comprise a matt paint.

The dome element may have an aperture defined therein. The aperture may be configured to enable a camera, which is positioned on one side of the dome element, to record an image of a component which is located at an opposite side of the dome element.

The diffuser may be configured to define a passage through which light scattered by the reflective surface of the dome can pass. This may be to allow illumination a component.

The inspection device may further comprise one or more further clusters of lights. Preferably the inspection device comprises at least two more clusters of lights.

The inspection device may further comprise a cluster of lights which are configured such that they can direct light axially towards a component which is being inspected.

The clusters of lights may be arranged at different vertical orientations. For example, a first cluster of lights may be arranged above a second cluster of lights, both of which may be arranged above a third cluster of lights. Each of these clusters of lights may be arranged above a cluster of lights which are configured to direct light axially towards a component.

The inspection device may further comprise a beam splitter. The beam splitter may be arranged to split light which is emitted by a cluster of lights which are configured direct light axially towards a component.

The cluster of lights may be arranged in a rectangle. The lights at each side of the rectangle may define a group of lights. The lights defining two or more sides of the rectangle may define a group of lights; for example the lights defining two sides of the rectangle may define a first group and the lights defining the other two sides of the rectangle may define a second group. The cluster of lights may be arranged in a rectangle which has the dimensions of between 20 mm-46 mm in length and 20 mm-46 mm in width. Preferably, the cluster of lights are arranged in a rectangle which has the dimensions of 36 mm in length and 36 mm in width.

The inspection device may further comprise second and third clusters of lights. The second cluster of lights may be arranged in a rectangle which has the dimensions of between 20 mm-46 mm in length and 20 mm-46 mm in width. Preferably, the second cluster of lights is arranged in a rectangle which has the dimensions 36 mm in length and 36 mm in width. The third cluster of lights may be arranged in a rectangle which has the dimensions of between 20 mm-46 mm in length and 20 mm-46 mm in width. Preferably, the third cluster of lights are arranged in a rectangle which has the dimensions 36 mm in length and 36 mm in width

The cluster of lights may be arranged in a circle. The lights defining the circle may be segmented. Each segment may define a group of lights. The lights defining two or more segments may define a group of lights; for example the lights defining two segments may define a first group and the lights defining another two segments may define a second group.

According to a further aspect of the present invention there is provided a lighting arrangement comprising, a cluster of lights; a first diffuser arranged to diffuse light coming from the cluster of lights; a dome element, wherein the dome element comprises a reflective surface which is configured to scatter light which has been diffused by the first diffuser, so as to provide light which has improved distribution.

Any of the afore-mentioned inspection devices, comprising a light arrangement according to the afore-mentioned lighting arrangement.

The dome element may comprise a surface which is configured to scatter light. The surface may be a matt surface. The surface may comprise a matt paint.

The dome element may have an aperture defined therein. The aperture may be configured to enable a camera, which is positioned on one side of the dome element, to record an image of a component which is located at an opposite side of the dome element.

The diffuser may be arranged to define a passage through which light scattered by the reflective surface of the dome can pass. The light scattered by the reflective surface of the dome can pass through the passage to illuminate a component which is to be inspected.

The cluster of lights may be arranged to define a passage through which light scattered by the reflective surface of the dome can pass, to allow illumination a component.

An inspection device, suitable for use when inspecting a component for defects, the inspection device comprising, any one of the afore-mentioned lighting arrangements.

According to a further aspect of the present invention there is provided a method of inspecting a component comprising the steps of, operating a cluster of lights which are arranged into two or more groups of lights such that each group of lights is operated asynchronously to the other group(s) of lights so that light is directed asynchronously, in different directions, at a component to be inspected; operating an image capturing means to capture an image of the component when each of the groups of lights are lit, to provide a plurality of images each image showing the component lit from a different direction; performing arithmetic computation using the images, so as to provide a single image in which defects in the component can be more easily identified.

### BRIEF DESCRIPTION OF THE DRAWINGS

An embodiment of the invention will now be described by way of example only, with reference to the accompanying drawings in which:

FIG. 1 shows a perspective view of an inspection device according to an embodiment of the present invention;

FIG. 2 provides a perspective view of a lighting arrangement according to aspect of the present invention;

FIG. 3 provides a perspective view of an inspection device according to an embodiment of the present invention, which uses a light arrangement according to an embodiment of the present invention.

### DETAILED DESCRIPTION OF POSSIBLE EMBODIMENTS OF THE INVENTION

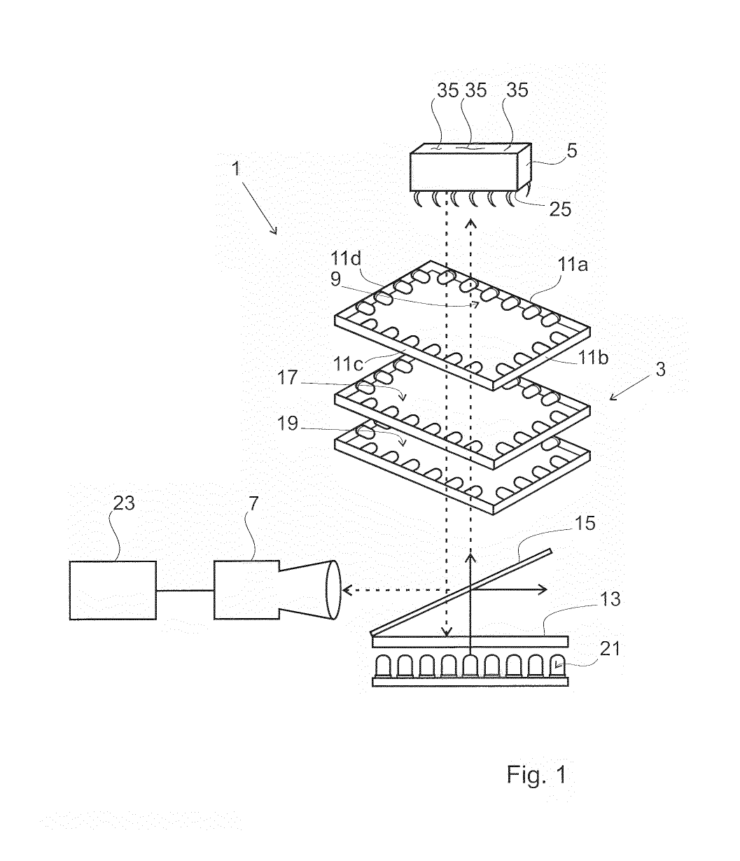

FIG. 1 provides a perspective view of an inspection device 1, suitable for use when inspecting a component for defects, according to one embodiment of the present invention. The inspection device 1 comprises a lighting system 3 which is suitable for use when in when inspecting a component 5 for defects. Typically, the lighting system 3 shown in FIG. 1 is used when inspecting an under-surface of a component for defect.

The lighting system 3 comprising a first cluster of lights 9 which are arranged in a rectangle with four sides 11a-d. In this particular example the lights defining sides 11a and 11c of the rectangle form a first group of lights, while the lights defining sides 11b and 11d of the rectangle form a second group of lights. So in this example, the cluster of lights 9 comprises two groups of lights (the group of lights which define sides 11a and 11c, the group of lights which define sides 11b and 11d).

It will be understood that the lights defining each side 11a-11d of the rectangle could form a group of lights, so the cluster of lights 9 comprises four groups of lights (the group of lights which define side 11a, the group of lights which define side 11b, the group of lights which define side 11c and the group of lights which define side 11d). It should be understood that the cluster of lights 9 could take any suitable form, for example the lights of the cluster 9 could be arranged in a circle (instead of being arranged in a rectangle) and wherein cluster of lights 9 defining the circle could be segmented, each segment defining a group of lights.

The lighting system 3 is configured such that at groups of lights operate asynchronously to one another so that the lights at sides 11a-d of the rectangle operate asynchronously to the lights at the sides 11a-d of the rectangle; this allows light to be directed asynchronously at a component 5, from different directions. In this particular example lighting system 3 is configured such the lights on the sides 11b and 11d light asynchronously to the sides 11a and 11c so that light can be directed asynchronously at a component, from different directions. However, it will be understood that any other combinations of asynchronisity could be used, for example the lighting system 3 could be configured such the lights on each of the sides 11a-d light asynchronously so that the component 5 can be lit asynchronously from four different directions.

In addition to the first cluster of lights 9, the lighting system further comprises a second and third cluster of lights 17,19 each of which are arranged in a rectangle. Unlike the first cluster of lights 9, the lighting system 3 is configured such that the lights which form the second and third cluster of lights, do not operate asynchronously, but rather operate synchronously so that all the lights of each of the second and third cluster of lights 17,19 light together or are off together. However, in this particular example, the lights of the second cluster of lights 17 can be turned on or off independently of the lights of the third cluster of lights 19, and vice versa. It should however be understood that the present invention is not restricted to having the lights of the second and third clusters 17,19 operating synchronously, the lights of the second and third clusters 17,19 could be configured to operate asynchronously in a similar fashion to the first cluster of lights 9.

The lighting system 3 further comprises a further cluster of lights 21 which are configured such that they can direct light axially towards a component 5 which is to be inspected. In this case the component 5 to be inspected will be illuminated from the side by the clusters of lights 9,17,19 which are arranged in a rectangle and will be illuminated at an under-surface 25 thereof, by the cluster of lights 21 which are configured to direct light axially towards a component 5. The cluster of lights 21 which direct light axially towards a component 5 are configured to provide light in a direction which is substantially perpendicular to the direction of light provided by the clusters of lights 9,17,19.

As can been seen in FIG. 1, each of said groups of lights 9, 17, 19, 21 are arranged at different vertical orientations; the first cluster of lights 9 is arranged above the second cluster of lights 17, both of which are arranged above the third cluster of lights 19. Each of these clusters of lights 9,17,19 are arranged above the cluster of lights 21 which are configured to direct light axially towards the component 5.

The lighting system 3 further comprises a diffuser 13 and a beam splitter 15. The diffuser 13 and beam splitter is arranged to diffuse and split light which is emitted by the cluster of lights 21 which provides the axial light. The diffuser 13 will ensure that the light incident on the component 5 from the cluster of lights 21 will be evenly distributed over the component 5. The diffuser will also help prevent a reflection of the cluster of lights 21 appearing on the under-surface 25 of the component 5 which is being inspected; a reflection of the cluster of lights 21 appearing on the under-surface 25 of the component 5 can appear in an image of an under-surface, thus impacting the clarity of the image.

The inspection device 1 further comprises a camera 7 which is used to take an image of the component 5 when it is lit by the lighting system 3. The camera 7 is configured such that it can obtain an image of the component 5 when the sides 11b and 11d are lighting and to take a further image of the component 7 when the sides 11a and 11c are lighting. Thus the camera records an image of the component when lit from each of the different directions. It will be understood that if the lighting system 3 was configured such the lights on each of the sides 11a-d light asynchronously so that the component 5 is lit asynchronously from four different directions; then the camera 7 could be configured to record an image of the component 5 when lit from each of the four directions, thus providing at least four images each image showing the component 5 lit from a different direction.

The inspection device 1 may further comprise an image processing module 23 which is configured to process each of the images obtained by the camera 7 (i.e. the image which were taken when the sides 11b and 11d were lit and the image which was taken when the sides 11a and 11c were lit). The image processing module 23 may be configured to carry out arithmetic computations with the images. In this particular embodiment the image processing module 23 is configured to carry out linear arithmetic computation using the images. For example the images may be divided, added or subtracted.

The arithmetic operations may be carried out pixel to pixel; for example, the addition of images may involve adding pixels of a first image which was obtained by the camera when sides 11b and 11d of the rectangle was lit, with the corresponding pixels of a second image which was obtained by the camera when another sides 11a and 11c of the rectangle was lit, to provide a single image whose pixels are an addition of the pixels of each of the first and second images. Likewise, subtracting the images, may involve subtracting the pixels of a first image from the corresponding pixels of a second image, to provide a single image whose pixels are a subtraction of the pixels of each of the first and second images. As discussed the inspection device 1 can be configured so that the lights on each of the sides 11a-d light asynchronously so that the component 5 is lit asynchronously from four different directions and the camera 7 can be configured to record an image of the component 5 when lit from each of the four directions, thus providing at least four images each image showing the component 5 lit from a different direction. In this particular case the arithmetic operations may be carried using the four images; for example, the four images may be added pixel to pixel, or subtracted pixel to pixel, to provide a single image.

During use the component 5 is inspected by operating the cluster of lights 9 such that each group of lights operate asynchronously to the other group(s) of lights so that light is directed asynchronously, in different directions, at a component to be inspected (in this particular example the sides 11a and 11c from a first group of light and the sides 11d and 11b from a second group of lights); operating an image capturing means to capture an image of the component when each of the groups of lights are lit, to provide a plurality of images each image showing the component lit from a different direction; performing arithmetic computation using the images, so as to provide a single image in which defects in the component can be more easily identified.

More specifically, the component 5 to be inspected is positioned above the first cluster of lights 9 such that it is located towards the centre of the cluster.

The lighting system 3 is then operated. In the first cluster of lights 9, lights on the sides 11b and 11d light asynchronously to the sides 11a and 11c so that light is directed asynchronously at a component, from different directions. All of the light in second and third cluster of lights 17,19, and in the cluster of lights 21 are operated simultaneously to light the component 5. Thus, at any one time the component is lit by means of the second and third cluster of lights 17,19, the cluster of lights 21 and either the lights from sides 11a and 11c of the first cluster 9 or the light 11b and 11d of the first cluster 9.

When the lights on sides 11b and 11d are lit (while the lights on sides 11a and 11c remain off) the component 5 is illuminated more in the direction in which sides 11b and 11d emit light. Light incident on the component 5 is reflected by the component 5 and defects 35 which are present on the component 5. Light reflected by the component 5 and its defects 35 is transmitted to the beam splitter 15 and is directed towards the camera 7 which forms a first image of the component 5 and its defects 35, using the reflected light. Defects 35 which are, for example, perpendicular to the direction of the light emitted by sides 11b and 11d (i.e. defects 35 which are substantially parallel to sides 11d and 11d) will cast a prominent shadow; as the lights on sides 11a and 11c are not lit, light from sides 11a and 11c will not light the shadow cast by said defects 35, accordingly the shadow cast will appear more prominent in the image taken by the camera 7. A more prominent shadow will enable the defects 35 on the component 5, which run substantially parallel to sides 11d and 11d, to be more easily identified in the first image.

Next the lights on sides 11a and 11c are lit (while the lights on sides 11d and 11b remain off) so that the component 5 is illuminated more in the direction in which sides 11a and 11c emit light. Light incident on the component 5 is reflected by the component 5 and defects 35 which are present on the component 5. Light reflected by the component 5 and its defects 35 is transmitted to the beam splitter 15 and is directed towards the camera 7 which forms a second image of the component 5 and its defects 35, using the reflected light. Defects 35 which are, for example, perpendicular to the direction of the light emitted by sides 11a and 11c (i.e. defects 35 which are substantially parallel to sides 11a and 11c) will cast a prominent shadow; as the lights on sides 11b and 11d are not lit, light from sides 11b and 11d will not light the shadow cast by said defects 35, accordingly the shadow cast will appear more prominent in the image taken by the camera 7. A more prominent shadow will enable the defects 35, which run substantially parallel to sides 11a and 11c, to be more easily identified in the second image.

The first and second images taken by the camera 7 are processed by the image processing module 23 to provide a single image in which all the defects (both those which run substantially parallel to sides 11a and 11c and those which run substantially parallel to sides 11d and 11d) are more clearly visible. In this particular example the step of processing the images includes the step of performing linear arithmetic computations using the first and second images. The arithmetic computations may be the addition, subtraction and/or division of the first and second images. For example, the addition of the first and second images may involve adding pixels of the first image, with the corresponding pixels of a second image, to provide a single image whose pixels are the addition of the pixels of each of the first and second images. The arithmetic computation carried out by the processed by the image processing module 23 to provide a single image, may be chosen on the basis of at least one of the following; the component 5 which is being inspected; the defects 35 which are to be indentified; or simply by trial and error.

Advantageously, the lighting system 3 of the present invention enables defects on the component to be more easily identified. The lighting system enables the component 5 under inspection to be illuminated more, from different directions, asynchronously. When the component 5 is illuminated more, from a particular direction, defects of a particular orientation will cast a definitive shadow. When the component 5 is illuminated more, from another direction, defects of another particular orientation will cast a definitive shadow. For example defects orientated perpendicular to the direction of the additional light will cast a definitive shadow; defects 35 which are, for example, parallel to the direction of the additional light will not cast such a prominent shadow. A camera 7 can be used to record an image of the component 5 when the component 5 is lit more from the different directions. These images can then be processed by the image processing module 23 to provide a single image in which the definitive shadows cast by all defects on the component are shown. The image processing module 23 may perform arithmetic computations using the images. The image processing module 23 may perform arithmetic computations such as adding, subtracting or dividing the pixels of each image, to form a single image. The shadows cast by a defect are used to identify the presence of a defect; more definitive shadows therefore enable defects to be more easily identified. Thus since the single image provided by the image processing module 23 will show the definite shadows cast by all defects which are in all orientations, the defects on the component can be more easily identified.

Furthermore as the lights forming sides 11d and 11b are not on while lights forming sides 11a and 11c are on, and vice-versa, the shadow cast by a defect 35 when the lights of sides 11d and 11b are on will not be lit by lights from sides 11a and 11c and vice versa; accordingly the shadows will appear more prominent in the image taken by the camera. Thus, using the lighting system of the present invention, a number of images can be obtained, each of which was taken when the component is illuminated more from a different direction. By illuminating the component asynchronously, from different directions, and taking an image of the component when it is illuminated more from each of the different directions, each defect will cast a prominent shadow which will be visible in at least one of the images take by the camera. These images can be processed by image processing module 23 to provide a single image in which all the prominent shadows, cast by all defects 35 on the component 5, are shown.

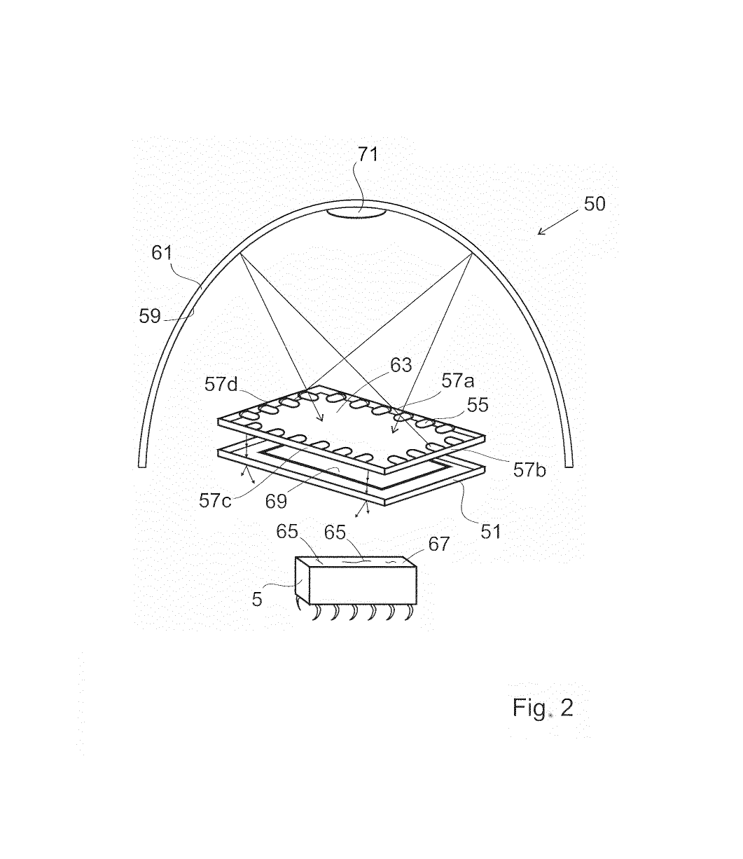

FIG. 2 provides a perspective view of a lighting arrangement 50 according to an embodiment of the present invention. Unlike the lighting system 3 shown in FIG. 1, the lighting arrangement 50 is typically used when inspecting an upper-surface 67 of a component 5. In this particular example the component 5 to be inspected in positioned below the lighting arrangement 50.

The lighting arrangement 50 comprises a cluster of lights 55 which are arranged in a rectangle; the cluster of lights 55 define the four sides 57a-d of the rectangle. It will also be understood that the cluster of lights 55 could be provided in any arrangement; for example the cluster of lights 55 could be arranged in a circle. The cluster of lights 55 could each light simultaneously, of could each light asynchronously.

In this particular example each side 57a-d defines a group of lights. The lighting arrangement 50 is configured such that each of the sides 57a-d (i.e. each group of lights) light asynchronously, so that light can be directed asynchronously at a component 5, from different directions. It will be understood that the lighting arrangement 50 could be configured to provide any other combination of asynchronous lighting; for example sides 57a and 57c could light simultaneously, but asynchronously to sides 57d and 57d, and vice versa. If for example the cluster of lights 55 is provided in another arrangement; for example the cluster of lights 55 are arranged in a circle; then the lights defining the circle could be segmented, each segment defining a group of lights. The group of lights will each light asynchronously, so that light can be directed, from different directions, asynchronously, at a component 5 under inspection.

The lighting arrangement 50 further comprises a first diffuser 51 which is arranged below the group of lights 55, so that it is interposed between the cluster of lights 55 and a component 5 which is to be inspected. The first diffuser 51 diffuses light which is emitted by the cluster of lights 55, directly downwards, towards the component 5 which is below the lighting arrangement 50. The first diffuser 51 will ensure that light emitted by the cluster of lights 55, directly downwards, towards the component 5 will be evenly distributed so that a surface of the component 5 (e.g. the upper surface 67 of the component) is illuminated uniformly.

The lighting arrangement 50 further comprises a second diffuser in the form of a dome element 61. The dome element 61 has an aperture 71 defined therein through which a camera can take an image of a component 5 which is positioned below the lighting arrangement 50. The dome element 61 comprises an inner surface 59 which is configured to reflect and scatter light. In this particular example the inner surface 59 is configured to reflect and scatter light by comprising a matt surface which is provided by a matt paint (not shown) which is present on the inner surface 59 of the dome element 61.

The first diffuser 51 has a passage 69 defined therein thought which light scatter from the dome element 6 can pass. Light which is scattered by the dome element 6 and which passes through the passage 59 in the first diffuser 51, will illuminate the component 5 which is positioned below the lighting arrangement 50.

During use light emitted by any of the sides 57a-d in the cluster of lights 55, upward, away from the component 5, is incident on the inner surface 59 of the dome element 61. The light incident on the inner surface 59 of the dome element 61 is reflected and scattered 61 so that at least some of the light passes back though a centre 63 of the rectangular cluster of lights 55 and through the passage 59 in the first diffuser 51, to be incident on the component 5 which is to be inspected. The light which is reflected and scattered due to the matt paint which is present on the inner surface 59 of the dome element 61. The scattering of light by the dome element 61 ensures that light will be evenly distributed over a surface of the component 5 which is to be inspected; thus the surface of the component 5 which is to be inspected (in this case the upper surface 67) will be illuminated uniformly by the light.

During use, each of the sides 57a-d light asynchronously, so that light is directed asynchronously at a component 5, from different directions. Thus, when each side 57a-d is lit, defects which are present on the upper-surface 67 of the component 5 will cast prominent shadows, depending on their orientation, allowing them to be easily identified. Advantageously, the first diffuser 51 and the second diffuser in the form of a dome element 61, ensure that the light from each of the sides 57a-d is evenly distributed in the direction in which that side 57a-d emits light; thus the component is evenly illuminated in the direction in which the side 57a-d emits light. As a results defects 65 which are positioned further away from a side 57a-d can still cast a prominent shadow, thus enabling the defect 65 to be more easily identified.

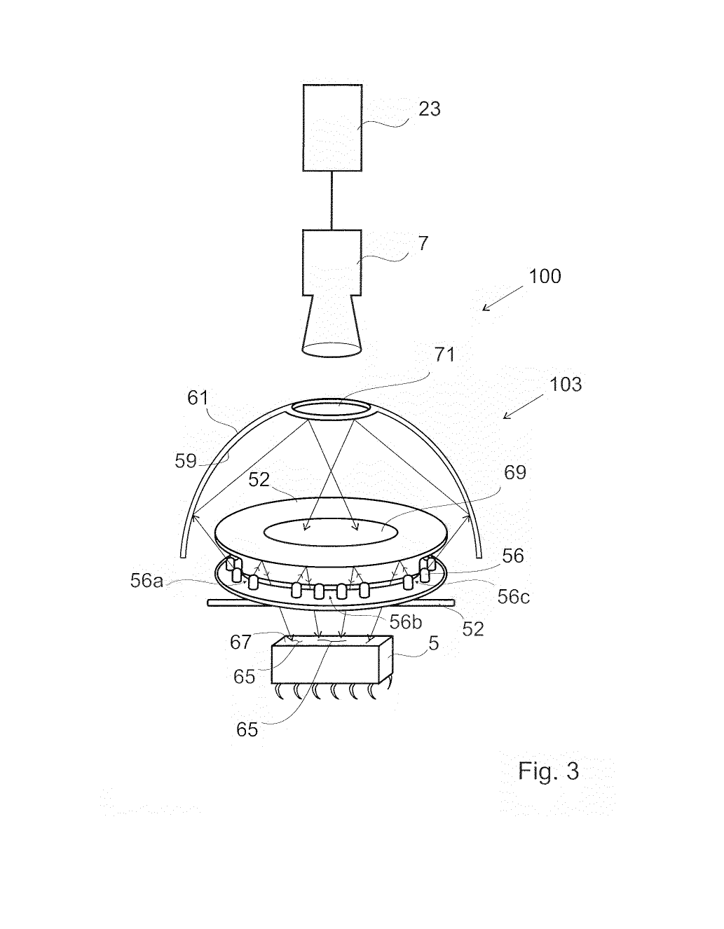

FIG. 3 provides a perspective view of an inspection device 100 according to an embodiment of the present invention, which uses a light arrangement according to a further embodiment of the present invention. The inspection device 100 is typically used to inspect an upper-surface 67 of a component 5. In this particular example the component 5 to be inspected in to be positioned below the lighting arrangement 103.

The lighting arrangement 103 shown in the inspection device 100 has many of the same features as the lighting arrangement 55 shown in FIG. 3 and like features are awarded the same reference numerals. Unlike the lighting arrangement 55 shown in FIG. 3 the lighting arrangement 103 shown in the inspection device 100 comprises a cluster of lights 56 which are arranged in a circle. The lights defining the circle are segmented, each segment defining a group of lights 56a, 56b, 56c; each group comprises four lights. Only three groups of lights are shown, but it will be understood that any number of groups of lights may be provided. It will be understood that the cluster of lights 56 is not limited to such a configuration for example the cluster of lights 56 could be arranged in a square or triangle etc.

The inspection device 100 further comprises a first diffuser 52. The first diffuser 52 is arranged to extend both above and below the cluster of lights 56 (the diffuser 52 is shown in FIG. 3 to extend through the centre of the cluster of lights 56 which are arranged in a circle). Thus, the first diffuser 52 will diffuse light which is both emitted downwards towards the component 5 under inspection and emitted upwards towards the dome element 61. Advantageously, the diffuser ensures that light is evenly distributed over a surface of the component 5 which is to be inspected; thus the surface of the component 5 which is to be inspected (in this case the upper surface 67) will be illuminated uniformly by the light. Furthermore, as the diffuser 53 extends above the cluster of lights 56, it prevents reflection of the lights onto the dome element 61 and onto the surface of the component 5 which is to be inspected (in this case the upper surface 67); thus a clearer image of the surface (upper surface 67) of the component can be obtained. The first diffuser 52 is circular to match the arrangement of the cluster of lights 56.

Similar to the inspection device 1 shown in FIG. 1, the inspection device 100 further comprises a camera 7 and an image processing module 23. Both the camera 7 and an image processing module 23 operate in a similar manner to the camera 7 and image processing module 23 shown in the inspection device 1.

In use, the groups of lights 56a, 56b, 56c are either lit simultaneously or asynchronously. In this particular example the groups of lights 56a, 56b, 56c are asynchronously so that the component 5 is lit more from different directions. Defects 65 on the upper surface 67 of the component 5 are illuminated uniformly, from a particular direction, depending of the group of lights which are on. The defects will cast a prominent shadow depending on its orientation and depending on the direction from which the component is being lit (i.e. depending on which of the groups of lights 56a, 56b, 56c is on). The camera 7 records an image of the component 5 when it is lit by each of the groups of lights 56a,56b, 56c; thus the camera 7 records a plurality of images each image showing the component lit from a different direction.

These images can then be processed by the image processing module 23 to provide a single image in which the definitive shadows cast by all defects on the component are shown. The image processing module 23 may perform arithmetic computations using the images. The image processing module 23 may perform arithmetic computations such as adding, subtracting or dividing the pixels of each image, to form a single image. The shadows cast by a defect are used to identify the presence of a defect; more definitive shadows therefore enable defects to be more easily identified. Thus since the single image provided by the image processing module 23 will show the definite shadows cast by all defects which are in all orientations, the defects on the component can be more easily identified.

Various modifications and variations to the described embodiments of the invention will be apparent to those skilled in the art without departing from the scope of the invention as defined in the appended claims. Although the invention has been described in connection with specific preferred embodiments, it should be understood that the invention as claimed should not be unduly limited to such specific embodiment.

1-15. (canceled)

16. An inspection device, suitable for use when inspecting a component for defects, the inspection device comprising:
a cluster of lights which are arranged into two or more groups of lights, wherein the cluster of lights is configured such that each group of lights can be operated asynchronously to the other group(s) of lights so that light can be directed asynchronously at a component, from different directions;
an image capturing means which is configured to capture an image of a component when each of the groups of lights are lit, to provide a plurality of images, each image showing the component lit from a different direction;
a processing means configured to perform arithmetic computation using the images, so as to provide a single image in which defects in the component can be more easily identified, wherein, the arithmetic computation comprises linear arithmetic computation, wherein the linear arithmetic computation comprises addition, subtraction and/or division of the images.

17. The inspection device according to claim 16, further comprising a diffuser.

18. The inspection device according to claim 16 further comprising a dome element which comprises a surface which is configured to scatter light.

19. The inspection device according to claim 18 wherein the dome element is configured to scatter light which has been defused by a diffuser.

20. The inspection device according to claim 16, further comprising one or more further clusters of lights.

21. The inspection device according to claim 20 wherein said clusters of lights are arranged at different vertical orientations.

22. The inspection device according to claim 16 further comprising a further cluster of lights which are configured such that they can direct light axially towards a component which is being inspected.

23. The inspection device according to claim 16 further comprising a beam splitter.

24. The inspection device according to claim 16 wherein the cluster of lights are arranged in a rectangle and wherein the lights at each side of the rectangle define a group of lights.

25. The inspection device according to claim 16 wherein the cluster of lights are arranged in a circle and wherein the lights defining the circle are segmented, each segment defining a group of lights.

26. The inspection device according to claim 16 comprising
a lighting arrangement comprising, the lighting arrangement comprising;
a cluster of lights;
a first diffuser arranged to diffuse light coming from the cluster of lights;
a dome element, wherein the dome element comprises a reflective surface which is configured to scatter light which has been diffused by the first diffuser, so as to provide light which has improved distribution.

27. The inspection device according to claim 26 wherein the cluster of lights define a passage through which light scattered by the reflective surface of the dome can pass, to allow illumination a component.

28. A method of inspecting a component comprising the steps of:
operating a cluster of lights which are arranged into two or more groups of lights such that each group of lights is operated asynchronously to the other group(s) of lights so that light is directed asynchronously, in different directions, at a component to be inspected;
operating an image capturing means to capture an image of the component when each of the groups of lights are lit, to provide a plurality of images each image showing the component lit from a different direction;
characterised in that the method further comprises,
performing arithmetic computation using the images, so as to provide a single image in which defects in the component can be more easily identified, wherein, the arithmetic computation comprises linear arithmetic computation which comprises addition, subtraction and/or division of the images.
